(19) United States
(12) Patent Application Publication
(10) Pub. No.: US 2015/0241042 A1
(43) Pub. Date: Aug. 27, 2015

(54) Pivotable LED Light Bulb Apparatus

(71) Applicant: QTOP USA, Inc., Holland, MI (US)

(72) Inventor: Boyd Edward Berends, Zeeland, MI (US)

(21) Appl. No.: 14/631,484

(22) Filed: Feb. 25, 2015

Related U.S. Application Data
(60) Provisional application No. 61/945,372, filed on Feb. 27, 2014.

(51) Int. Cl. F21V 21/30; F21K 99/00

(52) U.S. Cl. CPC F21V 21/30; F21K 9/1375; F21Y 2101/02

(57) ABSTRACT

A pivotable LED light bulb apparatus comprising a housing and an LED assembly. The housing has a lower portion attachable to a light socket and an upper portion. The upper portion has an LED assembly with a plurality of LED elements disposed thereon. The lower portion of the housing pivots relative to the upper portion of the housing.

### CROSS-REFERENCE TO RELATED APPLICATION

This application claims priority from U.S. Provisional Patent Application Ser. No. 61/945,372 entitled Pivotable LED Light Bulb Apparatus, filed Feb. 27, 2014, the entire specification of which is hereby incorporated by reference.

### BACKGROUND OF THE DISCLOSURE

1. Field of the Disclosure

The invention relates in general to lighting sources, and more particularly, to a pivotable LED light bulb apparatus that is configured as a replacement for standard incandescent and compact fluorescent (cfl) bulbs and particularly well suited for use where directional light is desired (such as a cage work light or a sconce, for example). It is not, however, limited to such use.

2. Background Art

It is well known in the art that the standard incandescent bulb, developed over a century ago, is an inefficient source of light; a substantial amount of energy is expended as heat. In recent decades, other sources of light have been developed, including, for example cfl's and the like. More recently, LED's have come of age and are heralded for their energy efficiency. Indeed, at each intensity level, LED elements are more efficient than their predecessor cfl and incandescent bulbs. Additionally, the life cycle of an LED based bulb is approximately three to five times that of a cfl and up to thirty to fifty times longer than an incandescent bulb.

However, problematically, LED elements generally have very uni-directional emission of light. It is often difficult to replicate the light pattern and intensity emitted by a cfl or an incandescent bulb by an LED based bulb. Thus, adoption of these types of bulbs has been slowed by the lack of proper performance in existing devices. Often a performance loss is noticed as the light is not as uniform, not spread in the same manner, and/or otherwise less than optimal.

Such a problem is even more pronounced where the LED based bulb is desired for use where directional light is desired. For example, it is difficult to utilize LED based bulbs in sconces and in cage work lights. That is, unless the bulb is perfectly turned, the light may be directed toward a wrong direction. With very little adjustment, the option is to either utilize the bulb with a less than optimal direction of light, or to utilize a LED based bulb that is omnidirectional, and rely on receiving a part of the light. In either case the solution is less than optimal.

It is therefore an objective to provide an LED based light bulb assembly that can be provided as a screw and/or plug replacement for existing applications wherein a cfl or an incandescent bulb has been heretofore utilized and in uses wherein directional light is desired.

### SUMMARY OF THE DISCLOSURE

The disclosure is directed to a pivotable LED light bulb apparatus comprising a housing and a LED assembly. The housing has a lower portion and an upper portion. The lower portion includes a body and a lower cap base. The lower cap base includes a thread structurally configured to engage a threaded light socket. The body including a lower rotation coupling. The upper portion includes a upper rotation coupling rotatably coupled to the lower rotation coupling of the lower portion. The upper portion has an upstand portion extending away from the lower portion. The upstand portion has a front face. The LED assembly includes a base support strip member on the front face of the upstand portion. The base support strip member has at least a plurality of LED elements disposed thereon. The LED elements are electrically coupled to the light socket.

In some configurations, the lower cap base has a thread axis of rotation within the threaded light socket. The upper portion rotates relative to the lower portion about a housing axis. The housing axis is collinear with the thread axis of rotation.

In some configurations, the front face is substantially planar and defines a plane, with the plane being substantially parallel to the housing axis.

In some configurations, the front face is substantially planar and defines a plane. The housing axis lies in the plane defined by the front face.

In some configurations, the upstand portion further includes a back face opposite the front face. The back face has a plurality of buttresses extending therefrom.

In some configurations, the buttresses are substantially perpendicular to the back face.

In some configurations, the base support strip member further includes a central strip portion and a pair of opposing side strip portions. Each of the central strip portion and the pair of opposing side strip portions each having a plurality of LED elements positioned thereon and in electrical communication with the lower cap base.

In some configurations, the pair of opposing side strip portions are substantially mirror images of each other about the central strip portion. The central strip portion is parallel to each of the opposing side strip portions.

In some configurations, the lower portion is pivotable relative to the upper portion through an angular rotation of approximately 90°.

In some configurations, the lower portion is pivotable relative to the upper portion through an angular rotation that is less than 360°. In such a configuration, full rotation is precluded.

In some configurations, the upper and lower rotation couplings define a circular configuration in a rotation plane. The upstand portion extends substantially perpendicular to the rotation plane. The upstand portion has a thickness substantially smaller than a diameter of the circular configuration.

In some configurations, the upstand portion further includes a back face. The front face and the back face being substantially parallel to each other to, in turn, define an upstand portion having a substantially uniform thickness.

In some configurations, the lower portion further includes a lower radiating portion which is conically shaped between the lower cap base to the lower rotation coupling. The lower rotation coupling defining a substantially circular configuration and the lower cap base, the lower radiating portion and the lower rotation coupling having a matching central axis extending therethrough.

In some configurations, the plurality of LED elements are spaced apart a predetermined distance from each other.

In some configurations, the plurality of LED elements direct light in an orientation that is generally perpendicular to the front face.

### BRIEF DESCRIPTION OF THE DRAWINGS

The disclosure will now be described with reference to the drawings wherein:

FIG. 1 of the drawings is a perspective view of the pivotable LED light bulb apparatus of the present disclosure;

FIG. 2 of the drawings is a front plan view of the pivotable LED light bulb apparatus of the present disclosure; and

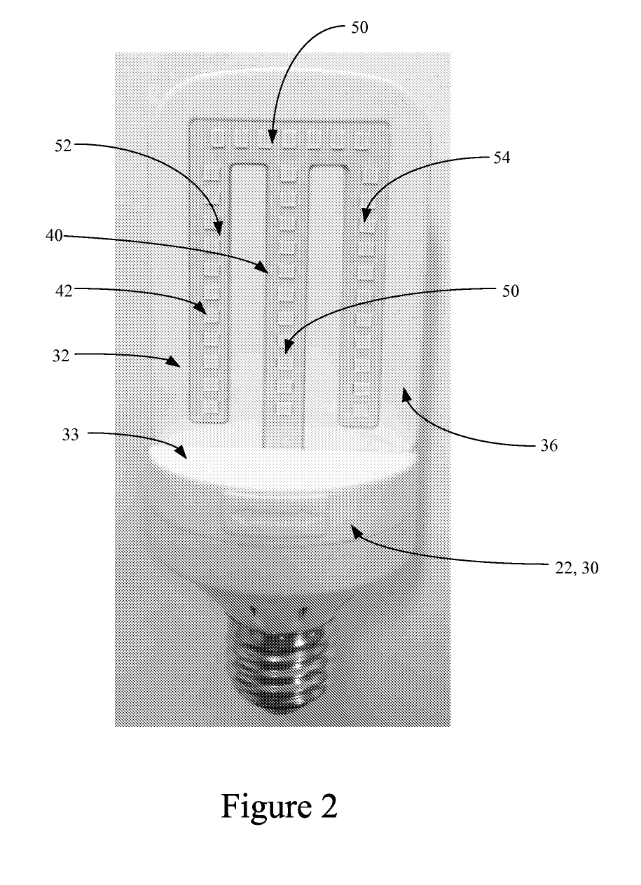

FIG. 3 of the drawings is a back plan view of the pivotable LED light bulb apparatus of the present disclosure.

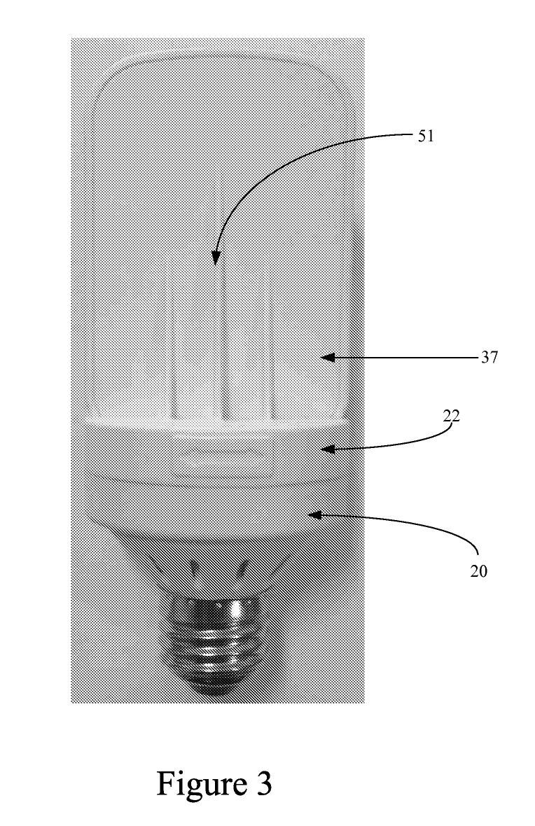

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

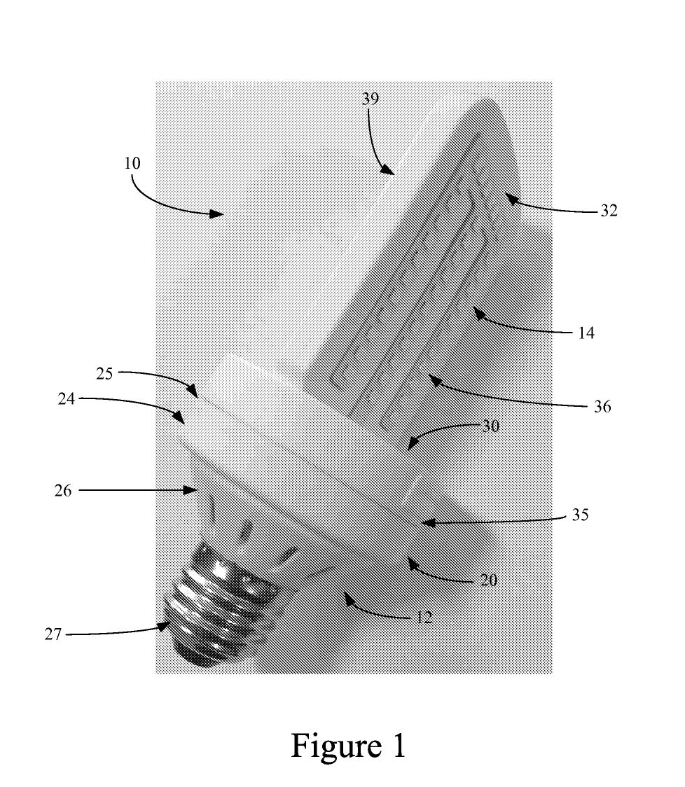

Referring now to the drawings and in particular to FIG. 1, the pivotable LED light bulb apparatus is shown at 10. The pivotable LED includes housing 12, LED assembly 14 and electrical driver (not shown). The pivotable LED is configured for use in association with a conventional screw base with a directional LED assembly, wherein the LED can be directed after the base has been coupled to the conventional attachment structures. As a result, the light can be directed as needed without dislodging from the coupling of the base.

More specifically, with reference to FIG. 1, the housing 12 includes lower portion 20 and upper portion 22. The lower portion 20 includes body 24 with lower rotation coupling 25, lower radiating portion 26 and lower cap base 27. The body 24 is of a generally circular configuration having a diameter which is generally configured to mimic a conventional incandescent light bulb. Of course, the configuration is not limited thereto. The lower radiating portion being directed/inclined inwardly to the lower cap base 27, in a frustoconical configuration. The lower radiating portion likewise includes a plurality of openings which are for passive heat dissipation. The lower cap base is shown as comprising a conventional E26 standard base which includes a threaded light socket configuration. Of course, other bases are contemplated, including smaller bases (i.e., candelabra, etc.) or larger (i.e., mogul, etc.) bases. Of course, other bases are likewise contemplated for use.

the lower cap base has a thread axis of rotation within the threaded light socket. The upper portion rotates relative to the lower portion about a housing axis. The housing axis is collinear with the thread axis of rotation.

The upper portion 22 is shown as comprising base 30 and upstand portion 32. The base includes top surface 33 and upper rotation coupling 35. The base generally has a substantially circular configuration, much like that of the body 24 of the lower portion 20. The top surface 33 is generally planar and is generally perpendicular to the axis of rotation of the base within the electrical connection socket. The two may be angled relative to each other in other embodiments, however, it will be understood that this may affect the path and direction of the light emanating from the LED elements 42.

The upper rotation coupling 35 interfaces with the lower rotation coupling 25. The couplings allow for relative rotation of the lower portion 20 and the upper portion 22 through at least a partial rotation. In the embodiment shown, it is contemplated that the lower portion and the upper portion are permitted to rotate about an axis of rotation that is generally the same as the rotation axis for the lower cap base (i.e., generally at or near the center of the generally circular configuration of the upper portion 22). While variations are contemplated, it is contemplated that the upper portion and the lower portion rotate relative to each other an arcuate distance of approximately 90°, while a greater or lesser rotation is likewise contemplated. It is contemplated that there can be rotation in either the clockwise or the counterclockwise direction.

The upstand portion 32 extends generally vertically from the top surface 33 of the base 30. The upstand portion 32 is typically perpendicular to the axis of rotation of the upper portion and the lower portion, although variations are contemplated. The upstand portion 32 includes front face 36, back face 37 and side edges 39. The back face 37 includes a plurality of buttresses 51 which provide support for the upstand portion. In the embodiment shown, the front and back faces are parallel to each other, and thereby define a substantially uniform thickness (which generally corresponds to the side edges 39). In other embodiments, each of the front and back faces may be other than parallel to each other, and may be other than planar (i.e., segmented or curved, among others).

As shown, the front face is substantially planar and defines a plane, with the plane being substantially parallel to the housing axis. The front face is substantially planar and defines a plane. The housing axis lies in the plane defined by the front face.

The LED assembly 14 is shown in FIG. 1 as comprising base support strip member 40 and LED elements, such as LED element 42, disposed on the base support strip member 40. The base support strip provides the electrical connections for the individual LED elements. The base support strip includes central strip portion which extends into the base of the upper portion (leading to the electrical driver), to a cross strip portion distally spaced from the top surface of the base 30. A pair of opposing side strip portions 52, 54 are positioned on either side of the central strip and extend from the cross strip on opposing ends thereof. LED elements are disposed along the different strip portions. Of course, other variations in the positioning of the LED elements is contemplated (such as other configured strips, for example, LED element patterns, and quantity of LED elements). In the embodiment shown, the LED elements are all mounted in a planar orientation on a substantially planar strip which is on a substantially planar front face 36. Variations to each of these is contemplated. However, it is contemplated that the LED elements are spaced apart a predetermined distance from each other, and that the LED elements direct light in an orientation that is generally perpendicular to the front face.

It is contemplated that the pivotable LED light bulb apparatus 10 be utilized in locations wherein the directionality is desirable. As an example, and by no means a limitation, the apparatus 10 is configured for use in association with work light cages, sconces and the like. It will be understood that when the apparatus is screwed into the light socket sufficiently to energize the apparatus, there is a little bit of range of rotation before reaching the end of rotation within the socket (this defines the range of operation).

Throughout the range of operation, the position of the LED assembly may be less than optimal. As such, the LED elements may be directing light in the wrong direction. With such a directional light source, this may be problematic. As a result, the user is able to rotate the upper portion of the housing without disrupting the position of the lower portion of the housing. In turn, the user can reorient the LED elements into the desired and optimal orientation. It will be understood that a rotation of approximately 90° is generally entirely sufficient to be able to optimally direct the light (especially when combined with the operating range of the socket into which the apparatus is inserted). In certain embodiments, the rotation is less than 360°, and full rotation is precluded. In other configurations, as little as 10-15° of rotation is needed to achieve the desired utilization and effect.

As a result, the user can utilize this type of apparatus with sconces and cage work lights to provide directional light, while being able to adjust the directionality of the same after coupling of the apparatus within the socket.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A pivotable LED light bulb apparatus comprising:
a housing having a lower portion and an upper portion, the lower portion includes a body and a lower cap base, the lower cap base including a thread structurally configured to engage a threaded light socket, the body including a lower rotation coupling, the upper portion including a upper rotation coupling rotatably coupled to the lower rotation coupling of the lower portion, the upper portion having an upstand portion extending away from the lower portion, the upstand portion having a front face; and
an LED assembly including a base support strip member on the front face of the upstand portion, the base support strip member having at least a plurality of LED elements disposed thereon, wherein the LED elements are electrically coupled to the light socket.

2. The pivotable LED light bulb apparatus of claim 1 wherein the lower cap base has a thread axis of rotation within the threaded light socket, and wherein the upper portion rotates relative to the lower portion about a housing axis, the housing axis being collinear with the thread axis of rotation.

3. The pivotable LED light bulb apparatus of claim 2 wherein the front face is substantially planar and defines a plane, with the plane being substantially parallel to the housing axis.

4. The pivotable LED light bulb apparatus of claim 3 wherein the front face is substantially planar and defines a plane, the housing axis lies in the plane defined by the front face.

5. The pivotable LED light bulb apparatus of claim 4 wherein the upstand portion further includes a back face opposite the front face, the back face having a plurality of buttresses extending therefrom.

6. The pivotable LED light bulb apparatus of claim 5 wherein the buttresses are substantially perpendicular to the back face.

7. The pivotable LED light bulb apparatus of claim 1 wherein the base support strip member further includes a central strip portion and a pair of opposing side strip portions, each of the central strip portion and the pair of opposing side strip portions each having a plurality of LED elements positioned thereon and in electrical communication with the lower cap base.

8. The pivotable LED light bulb apparatus of claim 7 wherein the pair of opposing side strip portions are substantially mirror images of each other about the central strip portion, and wherein the central strip portion is parallel to each of the opposing side strip portions.

9. The pivotable LED light bulb apparatus of claim 1 wherein the lower portion is pivotable relative to the upper portion through an angular rotation of approximately 90°.

10. The pivotable LED light bulb apparatus of claim 1 wherein the lower portion is pivotable relative to the upper portion through an angular rotation that is less than 360°, and wherein full rotation is precluded.

11. The pivotable LED light bulb apparatus of claim 1 wherein the upper and lower rotation couplings define a circular configuration in a rotation plane, with the upstand portion extending substantially perpendicular to the rotation plane, the upstand portion having a thickness substantially smaller than a diameter of the circular configuration.

12. The pivotable LED light bulb apparatus of claim 1 wherein the upstand portion further includes a back face, with the front face and the back face being substantially parallel to each other to, in turn, define an upstand portion having a substantially uniform thickness.

13. The pivotable LED light bulb apparatus of claim 1 wherein the lower portion further includes a lower radiating portion which is conically shaped between the lower cap base to the lower rotation coupling, the lower rotation coupling defining a substantially circular configuration and the lower cap base, the lower radiating portion and the lower rotation coupling having a matching central axis extending therethrough.

14. The pivotable LED light bulb apparatus of claim 1 wherein the plurality of LED elements are spaced apart a predetermined distance from each other.

15. The pivotable LED light bulb apparatus of claim 14 wherein the plurality of LED elements direct light in an orientation that is generally perpendicular to the front face.
